(19) United States
(12) Patent Application Publication
(10) Pub. No.: US 2005/0081987 A1
(43) Pub. Date: Apr. 21, 2005

(54) Manufacturing method for laminated electronic components

(75) Inventors: Wataru Takahara, Tokyo (JP); Hitoshi Tanaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/963,513

(22) Filed: Oct. 14, 2004

(30) Foreign Application Priority Data
Oct. 15, 2003 (JP) 2003-354615

(51) Int. Cl. B32B 31/00; G01D 1/00

(52) U.S. Cl. 156/250

(57) ABSTRACT

The present invention is directed to a manufacturing method for laminated electronic components which provides small cutting width and high degree of size precision and prevents defect occurrence after the baking process resulting from stress strain. In the manufacturing method, a laser beam 92 is applied onto a laminated green sheet 21 to cut it into laminated green chips 31 having a rectangular solid with a side of 0.6 mm or less and a side of 0.3 mm or less in dimensions measured after the baking process.

### BACKGROUND OF THE INVENTION

1. Field of the Invention

The present invention relates to a manufacturing method for laminated electronic components of small size.

2. Discussion of Background

Recently, miniaturization in electronic equipment has been developed, and miniaturization in electronic components, which are mounted in electronic equipment, also has been required. In such electronic components of small size, laminated electronic components have been the main stream of composite components incorporating various electronic components such as capacitors, coils and resistors.

Laminated electronic components are manufactured by laminating ceramic green sheets to obtain a laminated green sheet, then cutting the laminated green sheet into laminated green chips, which are to be separate electronic component elements, and baking the laminated green chips.

To cut a laminated green sheet, pressure cutting, rotary-blade cutting and laser cutting have conventionally been employed.

Pressure cutting is the method in which a cutter having a fixed blade like knife is used to press and cut a laminated green sheet. As a result, the laminated green sheet is displaced in both sides of the blade by the thickness of the blade, with gradual increase in the cutting displacement and a consequent wedged shape in the cross section of the cut. Furthermore, the cut has different cutting states in the thickness of the laminated green sheet and has a fracture surface in the latter half of the cutting process. In addition, the cutting performance degrades by wear of the cutting blade, and this causes defects such as considerable chip-to-chip variations in cutting size and stress strain in the laminated green chips that are obtained through the cutting process.

Rotary-blade cutting is the method in which a thin disk blade with abrasive grains is rotated. Accordingly, rotary-blade cutting has a considerable cutting width and friction heat. Thus, rotary-blade cutting requires cooling by water or the like and this necessitates an additional process of removing the water in the post-process. In addition, rotary-blade cutting has defects such as cutting size variations resulting from deflection and wear of the rotary blade, and crack occurrence after the baking process resulting from stress strain. Such defects are critical defects in electronic components of small size, and there has been the need for a cutting method of cutting a laminated green sheet with high degree of precision and stability.

JP1994-226689A and JP2001-53443A mention rotary-blade cutting and laser cutting. However, none of them discloses cutting laminated electronic components that are less than 1 mm in side.

### SUMMARY OF THE INVENTION

It is an object of the present invention to provide a manufacturing method for laminated electronic components which provides small cutting width and high degree of size precision.

It is a further object of the present invention to provide a manufacturing method for laminated electronic components which prevents defect occurrence after the baking process resulting from stress strain.

It is a still further object of the present invention to provide a manufacturing method for laminated electronic components which eliminates the need for cooling a laminated green sheet during the cutting process and provides reduction of the post-process.

In order to achieve the objects described above, the manufacturing method for laminated electronic components according to the present invention comprises a step of cutting a laminated green sheet. The aforesaid step of cutting a laminated green sheet comprises a step of applying a laser beam onto the laminated green sheet to cut it into laminated green chips having a rectangular solid with a side of 0.6 mm or less and a side of 0.3 mm or less in dimensions measured after the baking process.

In the manufacturing method for laminated electronic components described above, the cutting step for a laminated green sheet comprises a step of applying a laser beam onto the laminated green sheet to cut it into laminated green chips. A laser beam is easily focused to an extremely small cross section and its focal depth and irradiation position are controlled with high precision. This makes it possible to cut the laminated green sheet with small cutting width and high degree of size precision.

Furthermore, a laser beam has no mechanical stress on the laminated green sheet. This prevents the occurrence of stress strain in the laminated green chips.

The cutting step is executed so as to cut the laminated green sheet into laminated green chips having a rectangular solid with a side of 0.6 mm or less and a side of 0.3 mm or less in dimensions measured after the baking process. In such small sizes of laminated green chips, it is possible to prevent deposition of dielectric residue in the cutting step and inclination and unevenness of the cutting surface. As a result, precise cutting is achieved.

Furthermore, since no frictional heat is made, no cooling by water or the like is required and therefore no additional process of removing the water in the post-process is needed. As a result, reduction of the post-process is achieved.

As described above, the following effects can be obtained with the present invention.

(a) A manufacturing method for laminated electronic components can be provided which provides small cutting width and high degree of size precision.

(b) A manufacturing method for laminated electronic components can be provided which prevents defect occurrence after the baking process resulting from stress strain.

(c) A manufacturing method for laminated electronic components can be provided which eliminates the need for cooling a laminated green sheet during the cutting process and provides reduction of the post-process.

Other objects, structural features and advantages of the present invention are explained in further detail by referring to the attached drawings. The attached drawings are provided simply to illustrate specific examples.

### BRIEF DESCRIPTION OF DRAWINGS

FIG. 1 is a flow chart illustrating an embodiment of the manufacturing method for laminated electronic components according to the present invention;

FIG. 2 is a plan view illustrating one of the ceramic green sheets that are used in the manufacturing method for laminated electronic components according to the present invention;

FIG. 3 is a plan view illustrating another of the ceramic green sheets that are used in the manufacturing method for laminated electronic components according to the present invention;

FIG. 4 is a perspective view illustrating an example of the laminated green sheet that is used in the manufacturing method for laminated electronic components according to the present invention;

FIG. 5 is a schematic diagram illustrating an example of the cutting apparatus that is used in the manufacturing method for laminated electronic components according to the present invention;

FIG. 6 is a perspective view illustrating an example of the laminated green chip that is used in the manufacturing method for laminated electronic components according to the present invention; and

FIG. 7 is a perspective view illustrating an example of the laminated chip that is used in the manufacturing method for laminated electronic components according to the present invention.

### DESCRIPTION OF THE PREFERRED EMBODIMENTS

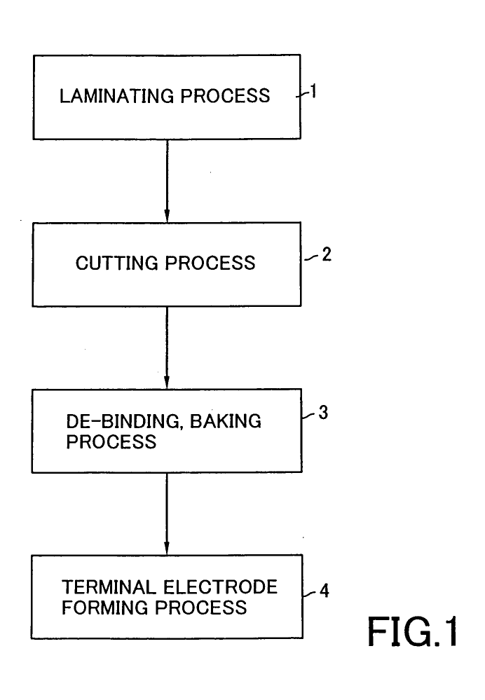

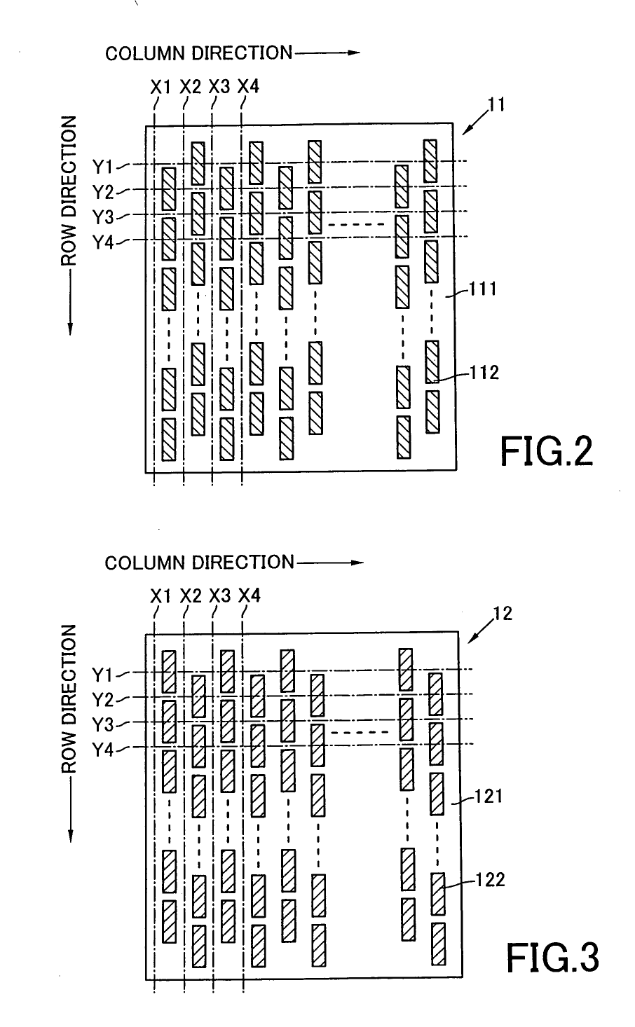

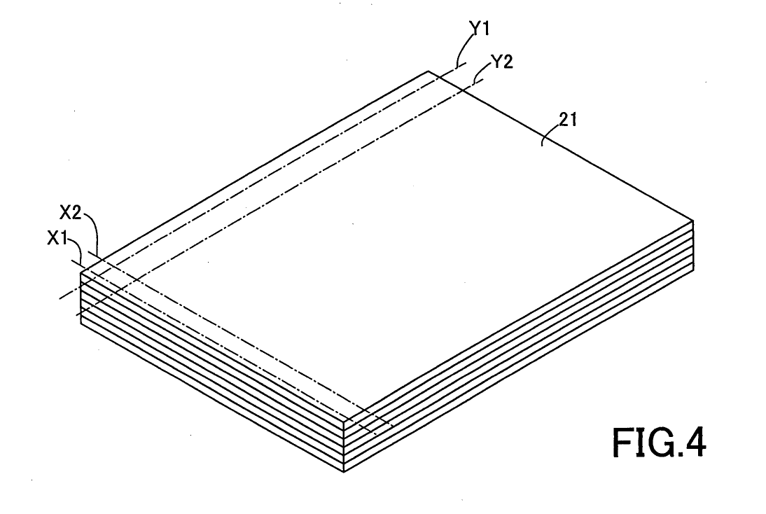

FIG. 1 is a flow chart illustrating an embodiment of the manufacturing method for laminated electronic components according to the present invention, FIGS. 2 and 3 are plan views illustrating the ceramic green sheets that are used in the embodiment of manufacturing method, and FIG. 4 is a perspective view illustrating an example of the laminated green sheet that is used in the embodiment of manufacturing method.

The embodiment of manufacturing method in the figures is an example in which the manufacturing method for laminated electronic components according to the present invention is applied to manufacturing of laminated chip capacitors. The embodiment of manufacturing method comprises a laminating process 1, a cutting process 2, a baking process 3 and a terminal electrode forming process 4. The laminating process 1 is a process of laminating a plurality of ceramic green sheets (unbaked ceramic sheets) 11, 12 to obtain a laminated green sheet (unbaked laminated sheet) 21. The cutting process 2 is a process of applying a laser beam onto the laminated green sheet 21 to cut it into a plurality of laminated green chips (unbaked laminated chips) 31. The baking process 3 is a process of baking the laminated green chips 31 to obtain laminated chips 41. The terminal electrode forming process 4 is a process of forming terminal electrodes on the end surfaces of the laminated chip 41.

With reference to FIGS. 2 and 3, the ceramic green sheet 11 (12) comprises a dielectric material sheet 111 (121) and a plurality of electrodes 112 (122). Dimensions of the ceramic green sheets 11, 12 are, in one example, 100 mm length by 100 mm width by 0.43 mm thickness.

Dimensions of the electrodes 112, 122 are, in one example, 0.2 mm length by 1.2 mm width by 1.2 μm thickness. The electrodes 112 (122) are arranged in a matrix on the dielectric material sheet 111 (121) by publicly-known printing method such as screen printing method.

In the electrodes 112 (122), adjacent columns of electrodes are arranged offset to each other by half of the electrode length in the column direction. With reference to the ceramic green sheet 11 and the ceramic green sheet 12, the electrode 112 and the electrode 122 in the same row and the same column are positioned offset to each other by half of the electrode length in the column direction.

In the laminating process 1, the ceramic green sheets 11 and the ceramic green sheets 12 are stacked in an alternating manner. Consequently, the electrode 112, 122 in adjacent layers are overlapped in the column direction and offset by half of the electrode length in the column direction. In addition, a number of dielectric material sheets 111 (121) with no electrodes thereon, are laminated on the top surface of the lamination of ceramic green sheets 11, 12. Then, the laminated ceramic sheet 21 illustrated in FIG. 4 is formed.

The ceramic green sheet 11 in FIG. 2 and the ceramic green sheet 12 in FIG. 3 are formed with two printing plates. However, in cases where only one type of ceramic green sheet is formed with one printing plate, the ceramic green sheets are stacked so that adjacent sheets are offset to each other by half of the electrode length.

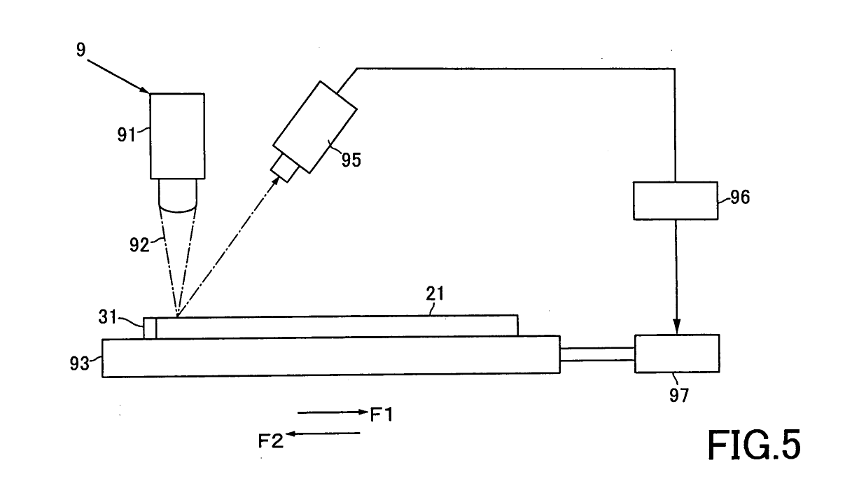

In the cutting process 2, the laminated ceramic sheet 21 is cut with a cutting apparatus. FIG. 5 is a schematic diagram illustrating an example of the cutting apparatus that is used in the cutting process of the embodiment of manufacturing method. The cutting apparatus 9 comprises a laser irradiation device 91, a stage 93, a monitor camera 95 and a shift device 97.

The laser irradiation device 91 applies a focused laser beam 92 onto the laminated green sheet 21 that is placed on the stage 93. The focused laser beam 92 is preferably YAG laser or CO₂ laser. In case of YAG laser, output of 50 W and a wavelength of 1.06 nm to 0.355 nm are suitable for use.

The stage 93 is a movable stage on which the laminated green sheet 21 is placed and which is shifted in X direction and Y direction in relation to the focused laser beam 92. The monitor camera 95 monitors the cutting position of the focused laser beam 92 and feeds the position information to the shift device 97 by way of a control computer 96 or the like.

The shift device 97 controls the shift of the stage 93, based on the position information. The shift device 97 shall make only a relative shift between the laminated green sheet 21 placed on the stage 93 and the focused laser beam 92, for example, in the directions indicated by the arrows F1, F2. Consequently, a configuration of shifting the laser irradiation device 91 may be adopted instead of the illustrated configuration of shifting the stage 93.

In the cutting process 2, the laminated ceramic sheet 21 is placed on the stage 93. The stage 93 is shifted under the position control by the shift device 97, which is based on the position information fed from the monitor camera 95. The laser irradiation device 91 applies the focused laser beam 92 at the cutting position in the laminated green sheet 21 to cut the laminated green sheet 21.

In the present invention, the laminated green chips shall be obtained which are 0.6 mm or less in long side (length) A, 0.3 mm or less in short side (width) B and 0.3 mm or less in thickness C in dimensions measured after the baking process. Accordingly, the cutting process 2 shall be executed so as to form the laminated green chips with larger dimensions than the above dimensions in terms of the shrink ratio. In this type of laminated green chip, the shrink ratio is 20% and then, the laminated green sheet shall be cut into the laminated green chips with the dimensions and shape back-calculated by this value.

The cutting process of the laminated green sheet will be explained, referring to FIGS. 2 to 4 and including the positional relationships of the electrodes 112 and the electrodes 122. In the cutting in the row direction, the cutting action on the broken line X1 is executed, for example by shifting the stage 93 in the row direction so as to apply the focused laser beam 92 on the broken line X1 on the left side of the left-most column.

Next, the stage 93 is shifted in the column direction to the broken line X2 between electrode columns. Then, the cutting action on the broken line X2 is executed by shifting the stage 93 in the row direction so as to apply the focused laser beam 92 on the broken line X2. After that, the same cutting action in the row direction is repeated for each line between electrode columns, in turn.

When the cutting in the row direction for each line between electrode columns is finished, the stage 93 is rotated 90 degrees and the cutting in the column direction is started. In the cutting in the column direction, the cutting action on the broken line Y1 is executed by shifting the stage 93 in the column direction so as to apply the focused laser beam 92 on the broken line Y1 on some upper sides and centers of electrodes in the top row.

Next, the stage 93 is shifted in the row direction to the broken line Y2 that is on some electrode centers of the top electrode row and between some adjacent electrode rows. Then, the cutting action on the broken line Y2 is executed by shifting the stage 93 in the column direction so as to apply the focused laser beam 92 on the broken line Y2. After that, the same cutting action in the column direction is repeated for each line on electrode centers and between electrode rows, in turn.

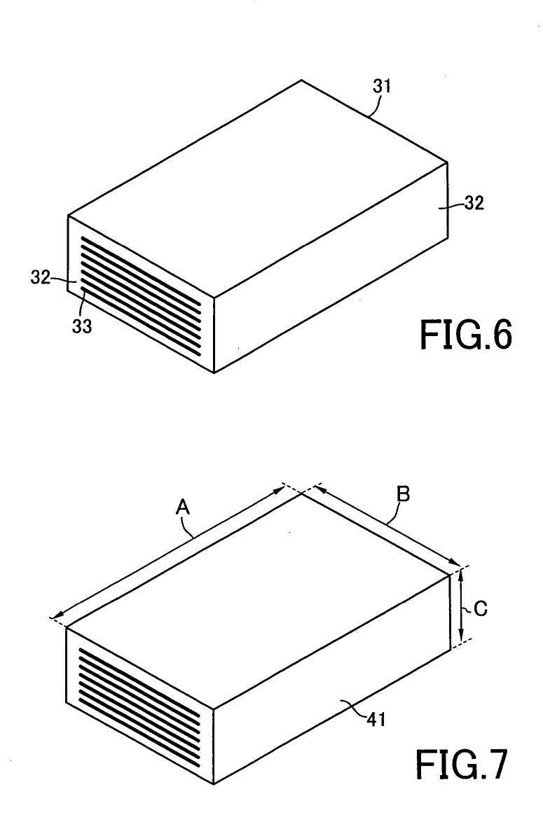

FIG. 6 is a perspective view illustrating an example of the laminated green chip that is obtained through the above-mentioned cutting process. The laminated green chip 31 is a rectangular solid, in which the end surfaces formed by the row-direction cutting are formed of dielectric layers 32, and the other end surfaces formed by the column-direction cutting are formed of dielectric layer 32 and electrode layers 33 exposed in alternating layers. There is a possibility of sinter on part of these end surfaces, which results from the laser beam irradiation. The sinter can be removed by polishing the end surface with the sinter thereon.

The laminated green chip 31 is baked in temperatures of 1200-1280° C. in the baking process and then a laminated chip 41 is obtained. FIG. 7 is a perspective view illustrating an example of the laminated chip obtained through the baking process. The laminated chip obtained through the baking process is a rectangular solid of 0.6 mm or less in long side (length) A, 0.3 mm or less in short side (width) B and 0.3 mm or less in thickness C. Accordingly, the cutting process for the laminated green chips shall be executed so as to form a solid with larger dimensions than the above dimensions in terms of the shrink ratio.

In the laminated chip obtained through the baking process, terminal electrodes are formed on the laminated chip and then a laminated chip capacitor is obtained.

A laser beam is easily focused to an extremely small cross section and its focal depth and irradiation position are controlled with high precision. This makes it possible to cut the laminated green sheet with small cutting width and high degree of size precision.

Furthermore, a laser beam has no mechanical stress on the laminated green sheet. This prevents the occurrence of stress strain in the laminated green chips.

Furthermore, since no frictional heat is made, no cooling by water or the like is required and therefore no additional process of removing the water in the post-process is needed. As a result, reduction of the post-process is achieved.

Even in case of sinter on the cutting end surfaces resulting from the laser beam irradiation, the sinter can be removed by barrel-polishing. Consequently, the adverse effect on the property is eliminated.

In order to ascertain the effects of the present invention, the inventors prepared the embodiments and comparison examples shown in Table 1 and conducted the comparative experiments. The experimental values shown in Table 1 are the values measured for 100 samples, which were randomly drawn from 10,000 laminated electronic components prepared for the experiment.

In the preparation of the laminated electronic components, a dielectric coating paste was prepared by mixing dielectric particles, binder and solvent and then, a dielectric material sheet was prepared by an applying process of the dielectric coating paste and the drying process thereof. In a non-limiting example, BaTiO₃ of 95 wet % or more was used as the dielectric material, and acrylic resin was used as the binder.

Next, a ceramic green sheet was prepared by printing electrode material on the dielectric material sheet. In a non-limiting example, Ni (nickel) was used as the electrode material. In each of embodiments 1 to 3 and comparison examples 1 to 5, the arrangement of electrodes was similar to that shown in FIGS. 2 and 3. The size of electrodes was set at the normal electrode size including the shrink rate in the baking process, wherein the normal electrode size relates to the target chip size after the baking process that was prescribed in each of embodiments 1 to 3 and comparison examples 1 to 5.

A laminated green sheet was prepared by laminating the ceramic green sheets. In each of embodiments 1 to 3 and comparison examples 1 to 5, the number of sheets laminated was set at the normal number of sheets including the shrink rate in the baking process, wherein the normal number of sheets relates to the target chip thickness after the baking process that was prescribed in each of embodiments 1 to 3 and comparison examples 1 to 5.

The methods of cutting a laminated green sheet are shown in Table 1. In the laser cutting method, the cutting apparatus illustrated in FIG. 5 was used to apply YAG laser of 50 W in output and 0.53 nm in wavelength onto the laminated green sheet and cut the laminated green sheet.

Next, the laminated green chips obtained through the cutting process were rounded at the corners thereof (rounding process) and then, the de-binding process was executed on the laminated green chips. After that, the baking process was executed at 1240° C. in a reducing atmosphere and then laminated chips were obtained. Table 1 shows the results of observations and measurements made on the laminated chips thus obtained.

TABLE 1

| | | | | | specified | process | percent |
|---|---|---|---|---|---|---|---|
| | | | specified | | length and | capability | defective |
| | | | length and | specified | width | (Cp) index | of electrode |
| | cutting | cutting | width | thickness | difference | in the | exposure |
| | method | state | (mm) | (mm) | (mm) | dimensions | defect (%) |
| comparison | pressure | | 0.6 × 0.3 | 0.3 | ±0.03 | 0.95 | 73.0 |
| example 1 | cutting | | | | | | |
| comparison | rotary-blade | | 0.6 × 0.3 | 0.3 | ±0.03 | 1.02 | 4.5 |
| example 2 | cutting | | | | | | |
| comparison | rotary-blade | | 0.4 × 0.2 | 0.2 | ±0.02 | 0.76 | 57.0 |
| example 3 | cutting | | | | | | |
| comparison | rotary-blade | | 0.2 × 0.1 | 0.1 | ±0.01 | the dimensions not | |
| example 4 | cutting | | | | | maintained | |
| comparison | laser cutting | rough and | 1.0 × 0.5 | 0.5 | ±0.05 | 1.33 | 0.08 |
| example 5 | | residue | | | | | |
| embodiment | laser cutting | good | 0.6 × 0.3 | 0.3 | ±0.03 | 1.45 | 0.12 |
| 1 | | | | | | | |
| embodiment | laser cutting | good | 0.4 × 0.2 | 0.2 | ±0.02 | 1.25 | 2.3 |
| 2 | | | | | | | |
| embodiment | laser cutting | good | 0.2 × 0.1 | 0.1 | ±0.01 | 1.05 | 3.6 |
| 3 | | | | | | | |

In Table 1, the specified length and width difference is an allowable difference in the specified length and width of the laminated chip. The percent defective of electrode exposure defect is a rate of exposure defect in which electrodes 112, 122 are exposed in a defective manner because of cutting displacement. In a percent defective of 4% or less, the laminated chip were regarded as conforming chips. The dimensions of laminated chips are shown in mm.

With reference to Table 1, comparison example 1 in which pressure cutting is used, has a high percent defective of electrode exposure defect and a low process capability index.

Comparison examples 2 to 4 in which rotary-blade cutting is used, have a high percent defective of electrode exposure defect. In comparison example 4 with the specified length and width set at 0.2 mm×0.1 mm, this value is not maintained in the manufacturing process.

In comparison example 5 in which laser cutting is used, the cutting surface is rough, and deposition of dielectric residue in the cutting step is observed, and inclination or unevenness of the cutting surface are observed. Comparison example 5 relates to laminated chips 1 mm in length, 0.5 mm in width and 0.5 mm in thickness. A large dimension of laminated chip, especially a large thickness causes problems with the cutting surface.

Embodiments 1 to 3 in which laser cutting is used, relate to small laminated chips of rectangular solid with a side of 0.6 mm or less and a side of 0.3 mm or less. Embodiments 1 to 3 has a good cutting state and has no problem in percent defective of electrode exposure defect and in process capability index.

In addition, embodiments 1 and 2 are superior in percent defective of electrode exposure defect and in process capability index, to comparison examples 2 and 3 in which rotary-blade cutting is used, though embodiments 1 and 2 are the same dimensions as comparison examples 2 and 3, respectively.

In comparison example 4 in which rotary-blade cutting is used to set the specified length and width at 0.2 mm×0.1 mm, this value is not maintained in the manufacturing process. However, in embodiment 3 in which laser cutting is used to set the same value as comparison example 4, the value is maintained in the manufacturing process, reducing the percent defective of electrode exposure defect to 3.6%.

As described above, the manufacturing method for laminated electronic components according to the present invention has a remarkable effect in connection with manufacturing small laminated chips of rectangular solid with a side of 0.6 mm or less and a side of 0.3 mm or less.

While the present invention have been described in detail with reference to the preferred embodiment thereof, the present invention is not limited to this embodiment and it is obvious that those skilled in the art can make various variations based on the basic technical idea and teachings of the invention.

1. A manufacturing method for laminated electronic components comprising a step of cutting a laminated green sheet, wherein:
said step of cutting a laminated green sheet comprises a step of applying a laser beam onto the laminated green sheet to cut it into laminated green chips having a rectangular solid with a side of 0.6 mm or less and a side of 0.3 mm or less in dimensions measured after the baking process.
